(19) United States
(12) Patent Application Publication
(10) Pub. No.: US 2004/0238732 A1
(43) Pub. Date: Dec. 2, 2004

(54) Methods and systems for dynamic virtual convergence and head mountable display

(76) Inventors: Andrei State, Chapel Hill, NC (US); Kurtis P Keller, Chapel Hill, NC (US); Jeremy D Ackerman, Chapel Hill, NC (US); Henry Fuchs, Chapel Hill, NC (US)

Correspondence Address: JENKINS & WILSON, PA, 3100 TOWER BLVD, SUITE 1400, DURHAM, NC, 27707, US

(21) Appl. No.: 10/492,582

(22) PCT Filed: Oct. 18, 2002
(86) PCT No.: PCT/US02/33597

Related U.S. Application Data
(60) Provisional application No. 60/335,052, filed on Oct. 19, 2001.

(51) Int. Cl. H01J 49/00

(52) U.S. Cl. 250/250; 250/281

(57) ABSTRACT

Methods and systems for dynamic virtual convergence (218) and a video see through head mountable display (200) that uses dynamic virtual convergence are disclosed. A dynamic virtual convergence algorithm (218) includes sampling an image with two cameras. The cameras each have a field of view that is larger than a field of view of displays used to display images sampled by the cameras (210). A heuristic is used to estimate the gaze distance of the viewer. The display frustums are transformed so that they converge at the estimated gaze distance. The images sampled by the cameras (210) are then reprojected into the transformed display frustums. The reprojected images are displayed to the user to simulate viewing of close range objects.

### RELATED APPLICATIONS

This application claims the benefit of U.S. Provisional Patent Application Ser. No. 60/335,052 filed Oct. 19, 2001, the disclosure of which is incorporated herein by reference In its entirety.

### GOVERNMENT INTEREST

This invention was made with Government support under Grant Nos. CA47287 awarded by National Institutes of Health, and ASC8920219 awarded by National Science Foundation. The Government has certain rights in the invention.

### TECHNICAL FIELD

The present invention relates to methods and systems for dynamic virtual convergence in video display systems. More particularly, the present invention relates to methods and systems for dynamic virtual convergence for a video-see-through head mountable display.

### RELATED ART

A video-see-through head mounted display (VSTHMD) gives a user a view of the real world through one or more video cameras mounted on the display. Synthetic imagery may be combined with the images captured through the cameras. The combined images are sent to the HMD. This yields a somewhat degraded view of the real world due to artifacts introduced by cameras, processing, and redisplay, but also provides significant advantages for implementers and users alike.

Most commercially available head-mounted displays have been manufactured for virtual reality applications, or, increasingly, as personal movie viewing systems. Using these off-the-shelf displays is appealing because of the relative ease with which they can be modified for video-see-through use. However, depending on the intended application, the characteristics of the displays frequently are at odds with the requirements for an augmented reality (AR) display.

One application for augmented reality displays is in the field of medicine. One particular medical application for AR displays is ultrasound-guided needle breast biopsies. This example is illustrated in FIG. 1. Referring to FIG. 1, a physician 100 stands at an operating table. Physician 100 uses a scaled, tracked, patient-registered ultrasound image 102 delivered through an AR system to select the optimal approach to a tumor, insert the biopsy needle into the tumor, verify the needle's position, and capture a sample of the tumor. Physician 100 wears a VST-HMD 104 throughout the procedure. During a typical procedure, physician 100 may look at an assistant a few meters away, medical supplies nearby, perhaps one meter away, patient 106 half a meter away or closer, and the collected specimen in a jar twenty centimeters from the physician's eyes. Display 104 must be capable of focusing on each of these objects. However, conventional HMDs have difficulty focusing on close-range objects.

Most commercially available HMDs are designed to look straight ahead. However, as the object of interest (either real or virtual) is brought closer to the viewer's eyes, there is a decreasing region of stereo overlap on the nasal side of the display for each eye that is dedicated to this object. Since the image content being presented to each eye is very different, the user is presumably unable to get any depth cues from the stereo display in such situations. Users of conventional parallel display HMDs have been observed to move either the object of interest or their head so that the object of interest becomes visible primarily in their dominant eye. From this configuration they can apparently resolve the stereo conflict by ignoring their non-dominant eye.

In typical implementations of video-see-through displays, cameras and displays are preset at a fixed angle. Researchers have previously designed VST-HMDs while making assumptions about the normal working distance. In one design discussed below, the video cameras are preset to converge slightly in order to allow the wearer sufficient stereo overlap when viewing close objects. In another design, the convergence of the cameras and displays can be selected in advance to an angle most appropriate for the expected working distance. Converging the cameras or both the cameras and the displays is only practical if the user need not view distant objects, as there is often not enough stereo overlap or too much disparity to fuse distant objects.

In the pioneering days of VST AR work, researchers improvised (successfully) by mounting a single lipstick camera onto a commercial VR HMD. In such systems, careful consideration was given to issues, such as calibration between tracker and camera [Bajura 1992]. In 1995, researchers at the University of North Carolina at Chapel Hill developed a stereo AR HMD [State 1996]. The device consisted of a commercial VR-4 unit and a special plastic mount (attached to the VR-4 with Velcro™), which held two Panasonic lipstick cameras equipped with oversized C-mount lenses. The lenses were chosen for their extremely low distortion characteristics, since their images were digitally composited with perfect perspective CG imagery. Two important flaws of the device emerged: (1) mismatch between the fields of view of camera (28° horizontal) and display (ca. 40° horizontal) and (2) eye-camera offset or parallax (see [Azuma 1997] for an explanation), which gave the wearer the impression of being taller and closer to the surroundings than she actually was. To facilitate close-up work, the cameras were not mounted parallel to each other, but at a fixed 4° convergence angle, which was calculated to also provide sufficient stereo overlap when looking at a collaborator across the room while wearing the device.

Today many video-see-through AR systems in labs around the world are built with stereo lipstick cameras mounted on top of typical VR (opaque) or optical-see-through HMDs operated in opaque mode (for example, [Kanbara2000]). Such designs will invariably suffer from the eye-camera offset problem mentioned above. [Fuchs 1998] describes a device that was designed and built from individual LCD display units and custom-designed optics. The device had two identical “eye pods.” Each pod consisted of an ultra-compact display unit and a lipstick camera. The camera's optical path was folded with mirrors, similar to a periscope, making the device “parallax-free” [Takagi2000]. In addition, the fields of view of camera and display in each pod were matched. Hence, by carefully aligning the device on the wearer's head, one could achieve near perfect registration between the imagery seen in the display and the peripheral imagery visible to the naked eye around each of the compact pods. Thus, this VST-HMD can be considered orthoscopic [Drascic1996], meaning that the view seen by the user through and around the displays appears consistent. Since each pod could be moved separately, the device (characterized by small field of view and high angular resolution) could be adjusted to various degrees of convergence (for close-up work or room-sized tasks), albeit not dynamically but on a per-session basis. The reason for this was that moving the pods in any way required inter-ocular recalibration. A head tracker was rigidly mounted on one of the pods, so there was no need to recalibrate between head tracker and eye pods. The movable pods also allowed exact matching of the wearer's IPD.

Other researchers have attacked the parallax problem by building devices in which mirrors or optical prisms bring the cameras “virtually” closer to the wearer's eyes. Such a design is described in detail in [Takagi2000], together with a geometrical analysis of the stereoscopic distortion of space and thus deviation from orthostereoscopy that results when specific parameters in a design are mismatched. For example, there can be a mismatch between the convergence of the cameras and the display units (such as in the device from [State1996]), or a mismatch between inter-camera distance and user IPD. While [Takagi2000] advocates rigorous orthostereoscopy, other researchers have investigated how quickly users adapt to dynamic changes in stereo parameters. [Milgram1992] investigated users' judgment errors when subjected to unannounced variations in intercamera distance. The authors in [Milgram 1992] determined that users adapted surprisingly quickly to the distorted space when presented with additional visual cues (virtual or real) to aid with depth scaling. Consequently, they advocate dynamic changes of parameters, such as inter-camera distance or convergence distance, for specific applications. [Ware1998] describes experiments with dynamic changes in virtual camera separation within a fish tank VR system. They used a z-buffer sampling method to heuristically determine an appropriate inter-camera distance for each frame and a dampening technique to avoid abrupt changes. Their results indicate that users do not experience “large perceptual distortions,” allowing them to conclude that such manipulations can be beneficial in certain VR systems.

Finally, [Matsunaga2000] describes a teleoperation system using live stereoscopic imagery (displayed on a monitor to users wearing active polarizers) acquired by motion-controlled cameras. The results indicate that users' performance was significantly improved when the cameras dynamically converged onto the target object (peg to be inserted into a hole) compared to when the cameras' convergence was fixed onto a point in the center of the working area.

Thus, one problem that emerges with conventional head mounted display systems is the inability to converge on objects close to the viewer's eyes. The display systems solve this problem using moveable cameras or cameras adjusted to a fixed convergence angle. Using moveable cameras increases the expense of head mounted display systems and decreases reliability. Using cameras that are adjusted to a fixed convergence angle only allows accurate viewing of objects at one distance. Accordingly, in light of the problems associated with conventional head mounted display systems, there exists a need for improved methods and systems for maintaining maximum stereo overlap for close range work using head mounted display systems.

### DISCLOSURE OF THE INVENTION

The present invention includes methods and systems for dynamic virtual convergence for a video see through head mountable display. The present invention also includes a head mountable display with an integrated position tracker and a unitary main mirror. The head mountable display may also have a unitary secondary mirror. The dynamic virtual convergence algorithm and the head mountable display may be used in augmented reality visualization systems to maintain maximum stereo overlap in close-range work areas.

According to one aspect of the invention, a dynamic virtual convergence algorithm for a video-see-through head mountable display includes sampling an image with two cameras. The cameras each have a field of view that is larger than a field of view of displays used to display the images sampled by the cameras. A heuristic is used to estimate the gaze distance of a viewer. The display frustums are transformed such that they converge at the estimated gaze distance. The images sampled by the cameras are then reprojected into the transformed display frustums. The reprojected image is displayed to the user to simulate viewing of close-range objects. Since conventional displays do not have pixels close to the viewer's nose, stereoscopic viewing of close range images is not possible without dynamic virtual convergence. Dynamic virtual convergence according to the present invention thus allows conventional displays to be used for stereoscopic viewing of close range images without requiring the displays to have pixels near the viewer's nose.

According to yet another aspect of the invention, a method for estimating the convergence distance of a viewer's eyes when viewing a scene through a video-see-through head mounted display is disclosed. According to the method, cameras sample the scene geometry for each of the viewer's eyes. Depth buffer values are obtained for each pixel in the sampled images using information known about stationary and tracked objects in the scene. Next, the depth buffers for each scene are analyzed along predetermined scan lines to determine a closest pixel for each eye. The closest pixel depth values for each eye are then averaged to produce an estimated gaze distance. The estimated gaze distance is then compared with the distances of points on tracked objects to determine whether the distances of points on any of the tracked objects override the estimated gaze distance. Whether a point on a tracked object should override the estimated gaze distance depends on the particular application. For example, in breast cancer biopsies guided using augmented reality visualization systems, the position of the ultrasound probe is important and may override the estimated gaze distance if that distance does not correspond to a point on the probe. The final gaze distance may be filtered to dampen high-frequency changes in the gaze distance and avoid high-frequency oscillations. This filtering may be accomplished by temporally averaging a predetermined number of recent calculated gaze distance values. This filtering step increases response time in producing the final displayed image. However, undesirable effects, such as jitter and oscillations of the displayed image due to rapid changes in the gaze distance are removed.

Once the final gaze distance is determined, the dynamic virtual convergence algorithm transforms the display frustums to converge on the estimated gaze distance and reprojects the image onto the transformed display frustums. The reprojected image is displayed to the viewer on parallel display screens to simulate what the viewer would see if the viewer were actually converging his or her eyes at the estimated gaze distance. However, actual convergence of the viewer's eyes is not required.

According to another aspect of the invention, a head mountable display includes either a single main mirror or two mirrors positioned closely to each other to allow camera fields of view to overlap. The head mountable display also includes an integrated position tracker that tracks the position of the user's head. The cameras include wide-angle lenses so that the camera fields of view will be greater than the fields of view of the displays used to display the image. The head mountable display includes a display unit for displaying sampled images to the user. The display unit includes one display for each of the user's eyes.

Accordingly, it is an object of the invention to provide a method for dynamic virtual convergence to allow viewing of close range objects using a head mountable display system.

It is another object of the invention to provide a video-see-through head mountable display with a unitary main mirror.

It is yet another object of the invention to provide a video-see-through head mountable display with an integrated tracker to allow tracking of a viewer's head.

Some of the objects of the invention having been stated hereinabove, and which are addressed in whole or in part by the present invention, other objects will become evident as the description proceeds when taken in connection with the accompanying drawings as best described hereinbelow.

### BRIEF DESCRIPTION OF THE DRAWINGS

Preferred embodiments of the invention will now be explained with reference to the accompanying drawings, of which:

FIG. 1 is an image of an ultrasound guided needle biopsy application for video-see-through head mounted displays;

FIG. 2 is a block diagram of a video-see-through head mountable display system including a dynamic virtual convergence module according to an embodiment of the present invention;

FIG. 3 is a flow chart illustrating exemplary steps that may be performed by a dynamic virtual convergence module in displaying images of a close range object to a viewer according to an embodiment of the present invention;

FIGS. 4A and 4B are images displayed on left and right displays of a video-see-through head mountable display according to an embodiment of the present invention;

FIG. 5 is an image of a video-see-through head mountable display including a unitary main mirror and an integrated tracker according to an embodiment of the present invention;

FIG. 6 is a top view of the display illustrated in FIG. 5;

FIG. 7 is an image of a scene illustrating stretching of a camera image to remove distortion in a dynamic virtual convergence algorithm according to an embodiment of the present invention;

FIG. 8 is an image of a scene illustrating rotating of display frustums to simulate viewing of close range objects in a dynamic virtual convergence algorithm according to an embodiment of the present invention;

FIG. 9 is a computer model of a scene that may be input to a dynamic virtual convergence algorithm according to an embodiment of the present invention;

FIG. 10 is an image illustrating the viewing of a scene with parallel displays and untransformed display frustums;

FIG. 11 is an image illustrating the viewing of a scene with parallel displays and rotated display frustums to provide dynamic virtual convergence according to an embodiment of the present invention;

FIG. 12 is an image illustrating the viewing of a scene with parallel displays and sheared display frustums to provide dynamic virtual convergence according to an embodiment of the present invention;

FIG. 13 includes left and right images of a scene illustrating sampling of the scene along predetermined scan lines to estimate gaze distance;

FIGS. 14A and 14B are images illustrating converged viewing of a scene through a VST HMD using dynamic virtual convergence according to an embodiment of the present invention;

FIG. 14C is an image of a scene corresponding to the converged views in FIGS. 14A and 14B;

FIGS. 15A and 15B are images illustrating parallel viewing of a scene through a VST HMD;

FIG. 15C is an image of a scene corresponding to the parallel views in FIGS. 15A and 15B;

FIG. 16A is an image of a researcher using a VST HMD with dynamic virtual convergence to view an object at close range; and

FIG. 16B corresponds to the view seen by the researcher in FIG. 16A.

### DETAILED DESCRIPTION OF THE INVENTION

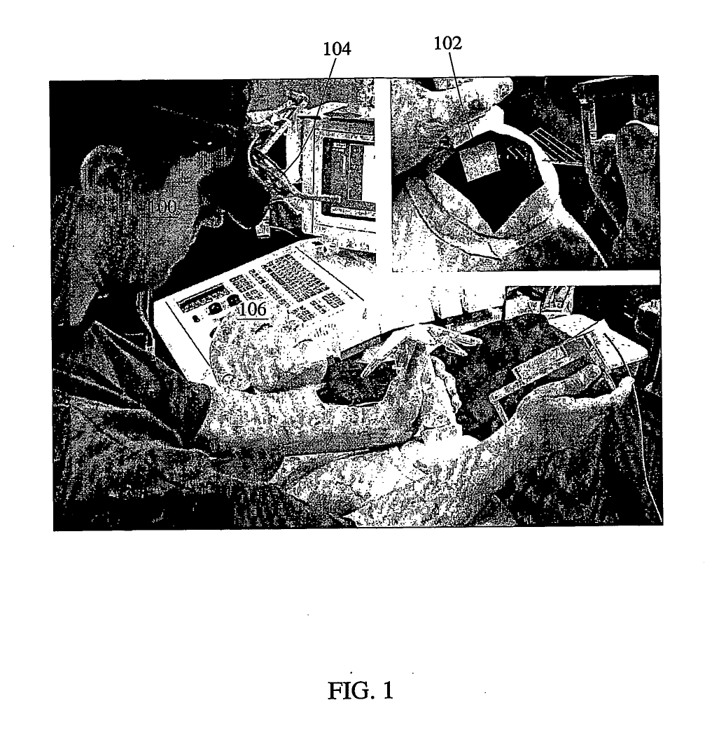

The present invention includes methods and systems for dynamic virtual convergence for a video see-through head mounted or head mountable display system. FIG. 1 is a block diagram of an exemplary operating environment for embodiments of the present invention. Referring to FIG. 1, a head mountable display 200, a computer 202, and a tracker 204 work in concert to display images of a scene 206 to a viewer. More particularly, head mountable display 200 includes tracking elements 208 for tracking the position of head mountable display 200, cameras 210 for obtaining images of scene 206, and display screens 212 for displaying the images to the user. Tracking elements 208 may be optical tracking elements that emit light that is detected by tracker 204 to determine the position of head mountable display 200. Scene 206 may include tracked objects 214 and untracked objects 216.

In order to allow the user to view images that are close to the user's eyes without moving parts, computer 202 includes a dynamic virtual convergence module 218. Dynamic virtual convergence module 218 estimates the viewer's gaze distance, transforms the images sampled by cameras 210 to simulate convergence of the viewers eyes at the estimated gaze distance, and reprojects the transformed images onto display screens 212. The result of displaying the transformed images to the user is that the images viewed by the user will appear as if the user's eyes were converging on a close range object. However, the user is not required to cross or converge his or her eyes on the image to view the close range object. As a result, user comfort is increased.

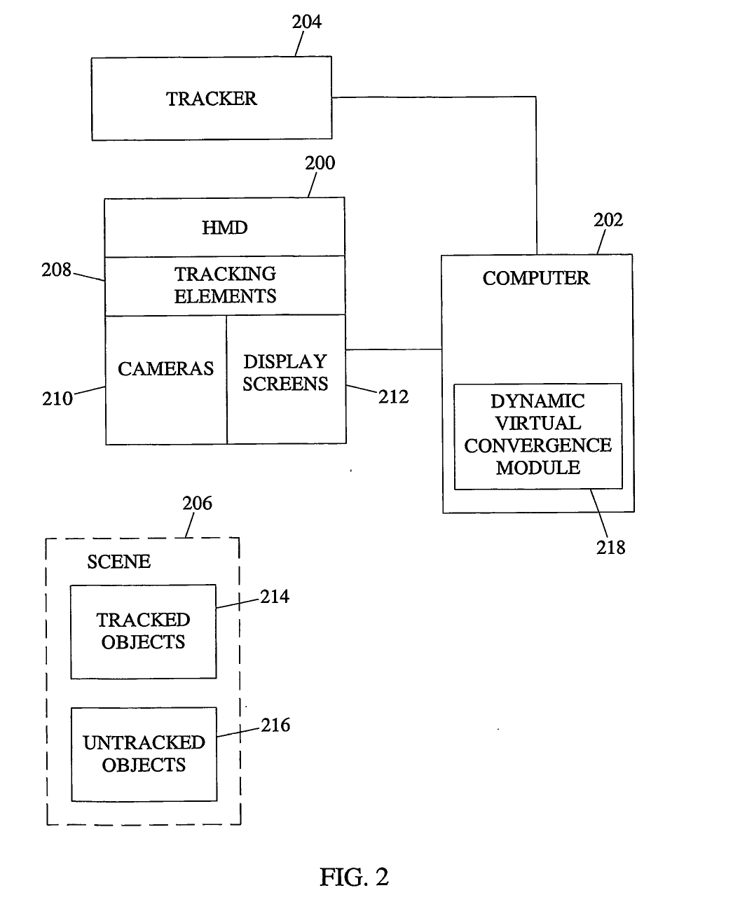

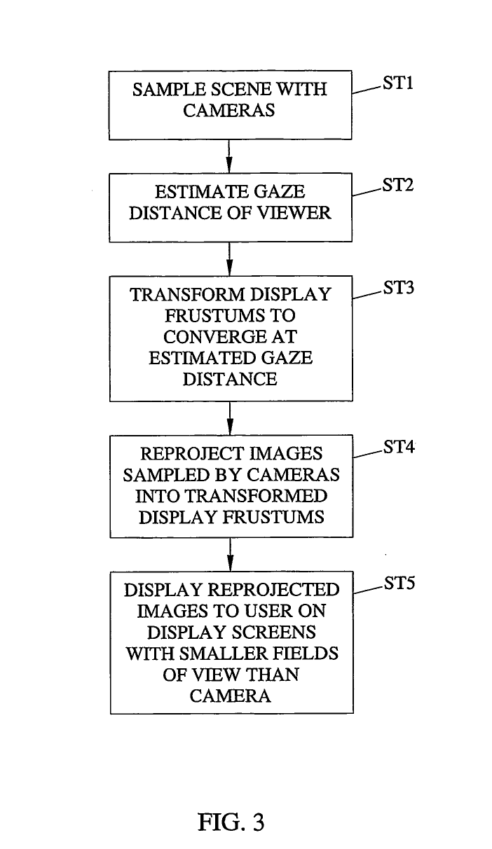

FIG. 3 is a flow chart illustrating exemplary overall steps that may be performed by dynamic virtual convergence module 218 and display 200 in displaying close range images to the user. Referring to FIG. 2, in step ST1, head mountable display 200 samples the scene with cameras 210. In step ST2, dynamic virtual convergence module 218 estimates the gaze distance of the user. In step ST3, dynamic virtual convergence module 218 transforms the display frustums to converge at the estimated gaze distance. In step ST4, dynamic virtual convergence module 218 reprojects the images sampled by the cameras in to the transformed display frustums. In step ST5, dynamic virtual convergence module 218 displays the reprojected images to the user on display screens 212. Display screens 212 have smaller fields of view than the cameras. As a result, there is no need to move the cameras to sample portions of the scene that would normally be close to the user's nose. An exemplary implementation of a VST HMD with a dynamic virtual convergence system according to the present invention will now be described in further detail.

### Dynamic Virtual Convergence System Implementation

The [Fuchs1998] device described above had two eye pods that could be converged physically. As each pod was toed in for better stereo overlap at close range, the pod's video camera and display were “yawed” together (since they were co-located within the pod), guaranteeing continuous alignment between display and peripheral imagery. The present embodiment deliberately violates that constraint but preferably uses “no moving parts,” and can be implemented fully in software. Hence, there is no need for recalibration as convergence is changed. It is important to note that sometimes VR or AR implementations mistakenly mismatch camera and display convergence, whereas the present embodiment intentionally decouples camera and display convergence in order to allow AR work in situations where an orthostereoscopic VST-HMD does not reach (because there are usually no display pixels close to the user's nose).

As described above, the present implementation uses a VST HMD with video cameras that have a larger field of view than the display unit. Only a fraction of a camera's image (proportional to the display's field of view) is actually shown in the corresponding display via re-projection. The cameras acquire enough imagery to allow full stereo overlap from close range to infinity (parallel viewing).

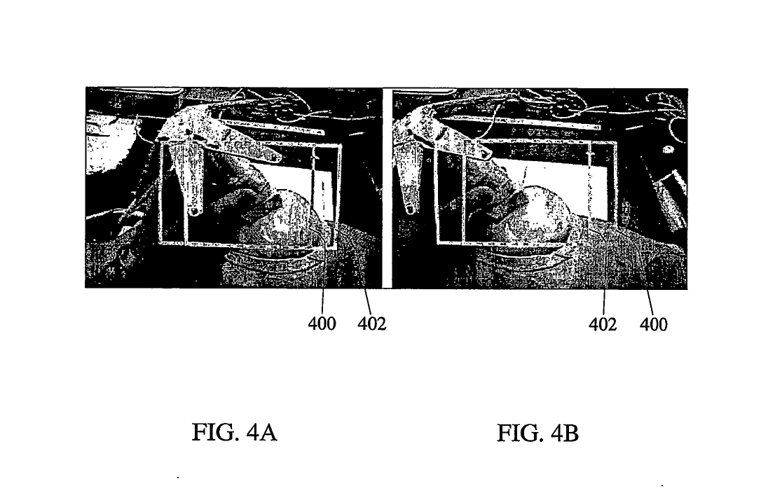

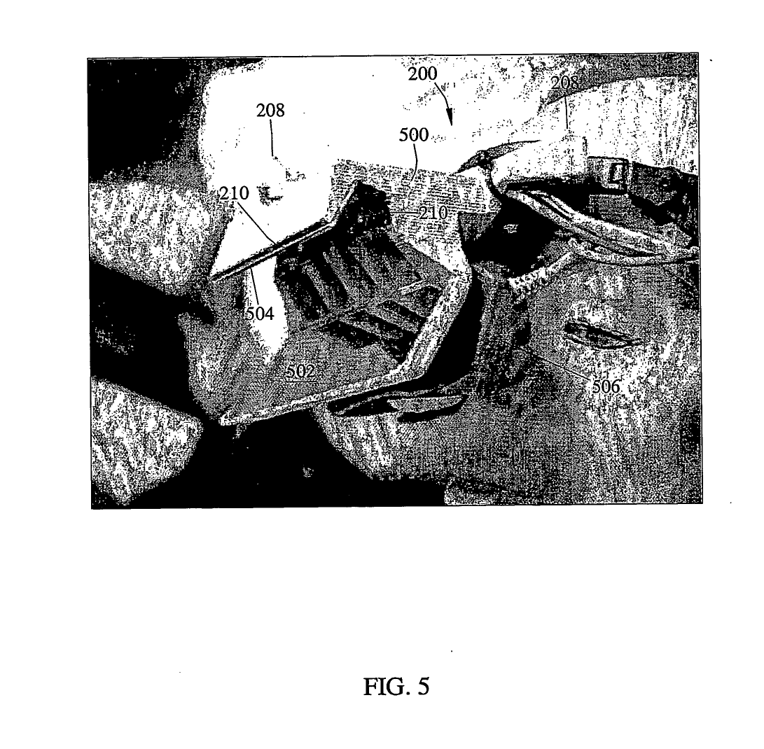

FIGS. 4A and 4B illustrate examples of sampling a scene using cameras having fields of view larger than the fields of view of the display screens in a video see through head mountable display. More particularly, FIGS. 4A and 4B are images of an ultrasound probe and a model breast cancer patient taken using left and right lipstick cameras in a video-see-through head mountable display according to an embodiment of the present invention. In FIGS. 4A and 4B, boxes 400 represent the fields of view of the display screens before the image is transformed using dynamic virtual convergence according to an embodiment of the present invention. Boxes 402 in each figure represent the images that will be displayed on the display screens after transformation using dynamic virtual convergence.

By enlarging the cameras' fields of view, the present invention removes the need to physically toe in the camera to change convergence. To preserve the above-mentioned alignment between display content and peripheral vision, the display would have to physically toe in for close-up work, together with the cameras, as with the device described in [Fuchs1998]. While this may be desirable, it has been determined that it may not be possible to operate a device with fixed, parallel-mounted displays in this way, at least for some users. This surprising finding might be easier to understand by considering that if the displays converged physically while performing a near-field task, the user's eyes would also verge inward to view the task-related objects (presumably located just in front of the user's nose). With fixed displays however, the user's eyes are viewing the very same retinal image pair, but in a configuration which requires the eyes to not verge in order for stereoscopic fusion to be achieved.

Thus, virtual convergence according to the present embodiment provides images that are aligned for parallel viewing. By eliminating the need for the user to converge her eyes, the present invention allows stereoscopic fusion of extremely close objects even in display units that have little or no stereo overlap at close range. This fusion is akin to wall-eyed fusion of certain stereo pairs in printed matter or to the horizontal shifting of stereo image pairs on projection screens in order to reduce ghosting when using polarized glasses. This fusion creates a disparity-vergence conflict (not to be confused with the well-known accommodation-vergence conflict present in most stereoscopic displays [Drascic1996]). For example, if converging cameras are pointed at an object located 1 m in front of the cameras and then present the image pair to a user in a HMD with parallel displays, the user will not converge his eyes to fuse the object but will nevertheless perceive it as being much closer than infinitely far away due to the disparity present in the image pair. This indicates that the disparity depth cue dominates vergence in such situations. The present invention takes advantage of this fact. Also, by centering the object of interest in the camera images and presenting it on parallel displays, the present invention eliminates the accommodation-vergence conflict for the object of interest, assuming that the display is collimated. In reality, HMD displays are built so that their images appear at finite but rather large (compared to the close range targeted by the present invention) distances to the user, for example, two meters in the Sony Glasstron device used in one embodiment of the invention (described below). Even so, users of a virtual convergence system will experience a significant reduction of the accommodation-vergence conflict, since virtual convergence reduces screen disparities (in one implementation of the invention, the screen is the virtual screen visible within the HMD). Reducing screen disparities is often recommended [Akka1992] if one wishes to reduce potential eye strain caused by the accommodationvergence conflict. Table 1 below shows the relationships between the three depth cues accommodation, disparity and vergence for a VST-HMD according to the present invention with and without virtual convergence, assuming the user is attempting to perform a close-range task.

TABLE 1
Depth cues and depth cue conflicts for close-range work:
Enabling virtual convergence maximizes stereo overlap for close-range
work, but “moves” the vergence cue to infinity

| | Available | Where are depth cues | | |
|---|---|---|---|---|
| Virtual | close-range | accommodation (A), disparity | | Conflicts |
| convergence | stereo | (D), and vergence (V) | | between |
| setting | overlap | Close-range | 2 m through ∞ | depth cues |
| OFF | partial | D, V | A | A-D, A-V |
| ON | full | D | A, V | A-D, D-V |

By eliminating the moving parts, the present embodiment provides the possibility to dynamically change the virtual convergence. The present embodiment allows the computer system to make an educated guess as to what the convergence distance should be at any given time and then set the display reprojection transformations accordingly. The following sections describe a hardware and software implementation of the invention and present some application results as well as informal user reactions to this technology.

### Exemplary Hardware Implementation

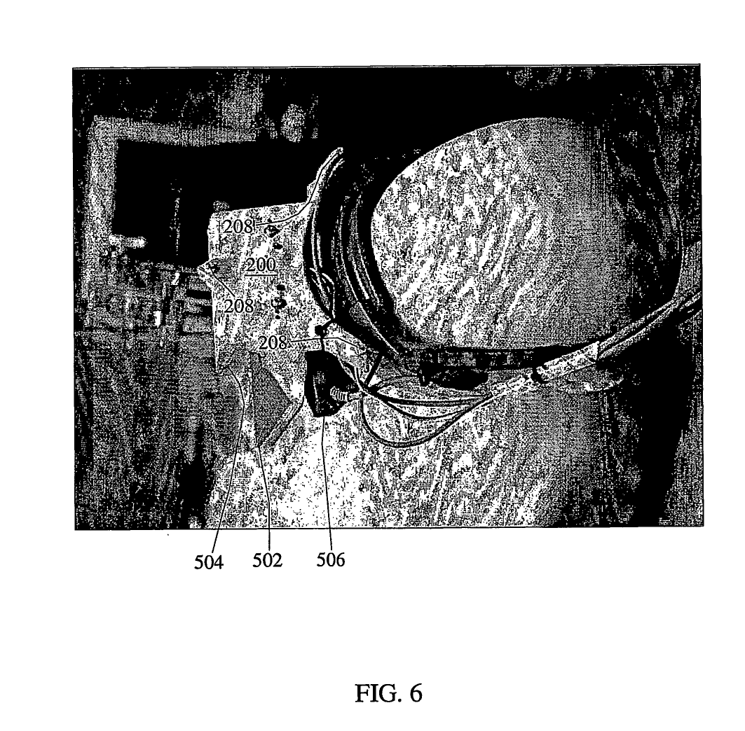

FIGS. 5 and 6 illustrate an exemplary head mountable display according to an embodiment of the present invention. Referring to FIG. 5, head mountable display 200 includes main body 500 on which optical tracking elements 208 are mounted. Mirrors 502 and 504 reproject the virtual centroids of cameras 210 to correspond to centroids of the users eyes. A display system 506 includes two LCD display screens for displaying real and augmented reality images to the user. A commercially available display unit suitable for use as display screens 506 is the Sony Glasstron PLM-S700 stereo display. Thus, using mirrors 502 and 504, the views seen by the user through and around displays 506 can be orthoscopic, depending on whether dynamic virtual convergence is on or off. If dynamic virtual conversion is on, the views seen by the viewer may be non-orthoscopic. If dynamic virtual convergence is off, the views seen by the user can be orthoscopic for objects that are not close to (>1 m away from) the user.

Referring to FIG. 6, it can be seen that tracking elements 208 are located at vertices of a triangle. Because tracking elements 208 are integrated within head mountable display 200, an accurate determination of where the user is looking is possible. In addition, because mirrors 502 and 504 are of unitary construction, the same mirror can be used by both cameras to sample pixels close to the viewer's nose. Thus, using a unitary main mirror, the present invention allows the cameras to share the same reflective plane and provides optical overlap of images sampled by the cameras.

In one non-orthoscopic embodiment, display 200 comprises a Sony Glasstron LDI-D100B stereo HMD with full-color SVGA (800×600) stereo displays, a device found to be very reliable, characterized by excellent image quality even when compared to considerably more expensive commercial units. Dynamic virtual convergence module 218 is operable with both orthoscopic and nonorthoscopic displays. It has a horizontal field of view of (=26°. The display-lens elements are built d=62 mm apart and cannot be moved to match a user's inter-pupillary distance (IPD). However, the displays' exit pupils are large enough (Robinett1992] for users with IPDs between roughly 50 and 75 mm. Nevertheless, users with extremely small or extremely large IPDs will perceive a prismatic depth plane distortion (curvature) since they view images through off-center portions of the lenses; this issue is not described in further detail herein. Cameras 210 may be Toshiba IK-M43S miniature lipstick cameras mounted on display 200. The cameras are mounted parallel to each other. The distance between them is also 62 mm. There are no mirrors or prisms, hence there is a significant eye-camera offset (about 60-80 mm horizontally and about 20-30 mm vertically, depending on the wearer). In addition, there is an IPD mismatch for any user whose IPD is significantly larger or smaller than 62 mm.

The head-mounted cameras 210 are fitted with 4-mm-focal length lenses providing a field of view of approximately β=50° horizontal, nearly twice the displays' field of view. It is typical for small wide-angle lenses to exhibit barrel distortion, and in one embodiment of the invention, the barrel distortion is nonnegligible and must be eliminated (per software) before attempting to register any synthetic imagery to it. The entire head-mounted device, consisting of the Glasstron display, lenses, and an aluminum frame on which cameras and infrared LEDs for tracking are mounted, weighs well under 250 grams. (Weight was an important issue in this design since the device is used in extended medical experiments and is often worn by a medical doctor for an hour or longer without interruption.) AR software suitable for use with embodiments of the present invention runs on an SGI Reality Monster equipped with InfiniteReality2 (IR2) graphics pipes and digital video capture boards. The HMD cameras' video streams are converted from S-video to a 4:2:2 serial digital format via Miranda picoLink ASD-272p decoders and then fed to two video capture boards. HMD tracking information is provided by an Image-Guided Technologies FlashPoint 5000 opto-electronic tracker. A graphics pipe in the SGI delivers the stereo left-right augmented images in two SVGA 60 Hz channels. These images are combined into the single-channel left-right alternating 30 Hz SVGA format required by the Glasstron with the help of a Sony CVI-D10 multiplexer.

### Exemplary Software Implementation

AR applications designed for use with embodiments of the present invention are largely single-threaded, using a single IR2 pipe and a single processor. For each synthetic frame, a frame is captured from each camera 210 via the digital video capture boards. When it is important to ensure maximum image quality for close-up viewing, cameras 210 are used to capture two successive National Television Standards Committee (NTSC) fields, even though that may lead to the well-known visible horizontal tearing effect during rapid user head motion.

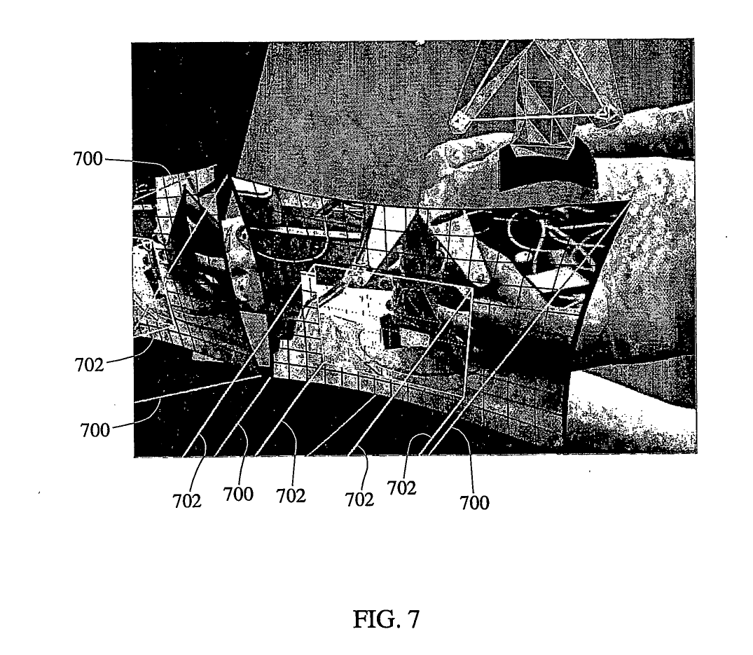

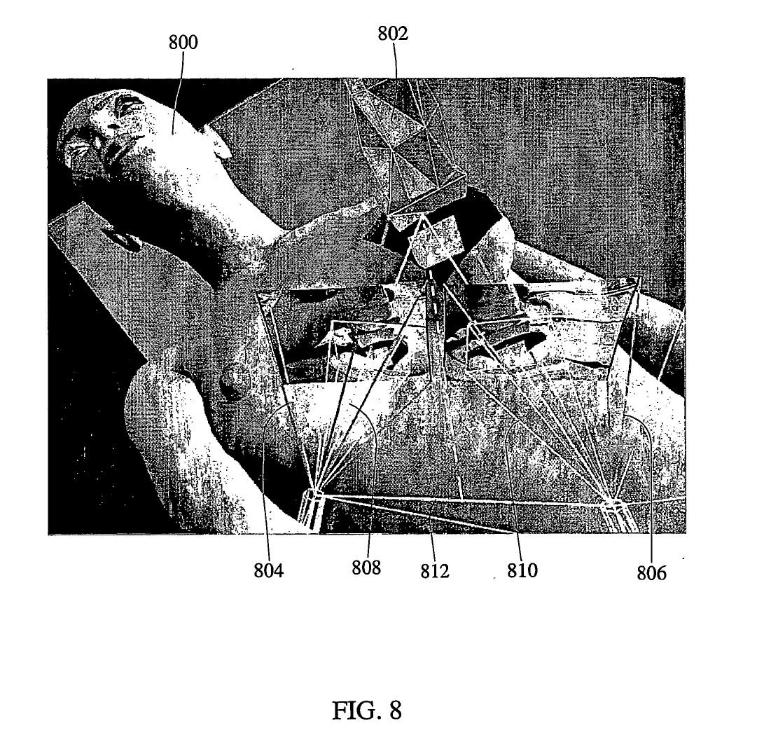

Captured video frames are initially deposited in main memory, from where they are transferred to texture memory of computer 202. Before any graphics can be superimposed onto the camera imagery, it must be rendered on textured polygons. Dynamic virtual convergence module 218 uses a 2D polygonal grid which is radially stretched (its corners are pulled outward) to compensate for the above mentioned lens distortion, analogous to the pre-distortion technique described in [Watson1995]. FIG. 7 illustrates the use of radial stretching of a 2D polygonal grid to remove lens distortion. Referring to FIG. 7, the volumes defined by lines 700 represent the frustums of the left and right cameras 210. The volumes defined by lines 702 represent the smaller display frustums used to define the image displayed to the user. The distortion compensation parameters are determined in a separate calibration procedure. Using this procedure, it was determined that both a third-degree and a fifth-degree coefficient are needed in the polynomial approximation [Robinett1992]. The stretched, video-texture-mapped polygon grids are rendered from the cameras' points of view (using tracking information from the FlashPoint unit and inter-camera calibration data acquired during yet another separate calibration procedure).

In a conventional video-see-through application one would use parallel display frustums to render the video textures since the cameras are parallel (as recommended by [Takagi2000]). Also, the display frustums should have the same field of view as the cameras. However, for virtual convergence, dynamic virtual convergence module 218 uses display frustums that are verged in. Their fields of view are equal to the displays' fields of view. As a result of that, the user ends up seeing a reprojected (and distortion-corrected) sub-image in each eye.

FIG. 8 illustrates camera frustums, rotated display frustums, and the corresponding images. In FIG. 8, a computer model 800 represents a breast cancer patient. Object 802 represents a model of an ultrasound probe. Conic section 804 represents the display frustum of the left camera in display 200. Conic section 806 represents the frustum of the right camera of display 200. Conic sections 808 and 810 represent the frustums of the left and right video displays displayed to the user. Isosceles triangle 812 represents convergence of the display frustums.

The maximum convergence angle is δ=β−α, which in the present implementation is approximately 24°. At that convergence angle, the stereo overlap region of space begins at a distance z_{over,min}=0.5 d tan(90°-β/2), which in the present implementation was approximately 66 mm, and full stereo overlap is achieved at a distance z_{over,full}=d/(tan(β/2)-tan(α-β/2)), which in the present implementation was about 138 mm. At the latter distance, the field of view subtends an area that is d+2z_{over,full} tan(α-β/2) wide, or approximately 67 mm in the implementation described herein.

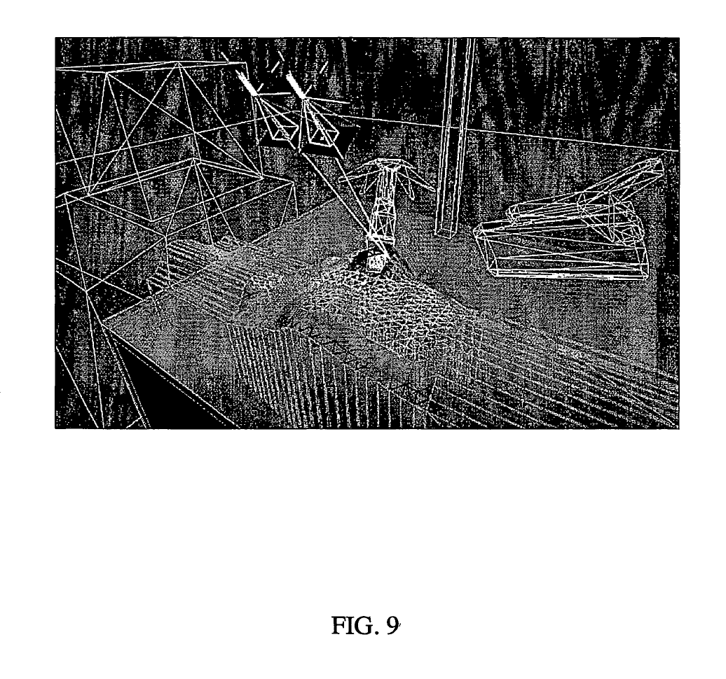

After setting the display frustum convergence, application-dependent synthetic elements are rasterized using the same verged, narrow display frustums. For some parts of the real world registered geometric models are stored in computer 202, and these models may be rasterized in Z only, thereby priming the Z-buffer for correct mutual occlusion between real and synthetic elements [State1996]. FIG. 9 illustrates an exemplary computer model of real and synthetic elements of a scene. As shown in FIG. 9, only part of the patient surface is known. The rest is extrapolated with straight lines to approximately the size of a human. There are static models of the table and of the ultrasound machine illustrated in FIG. 1, as well as of the tracked handheld objects [Lee2001]. Floor and lab walls are modeled coarsely with only a few polygons.

### Sheared vs. Rotated Display Frustums

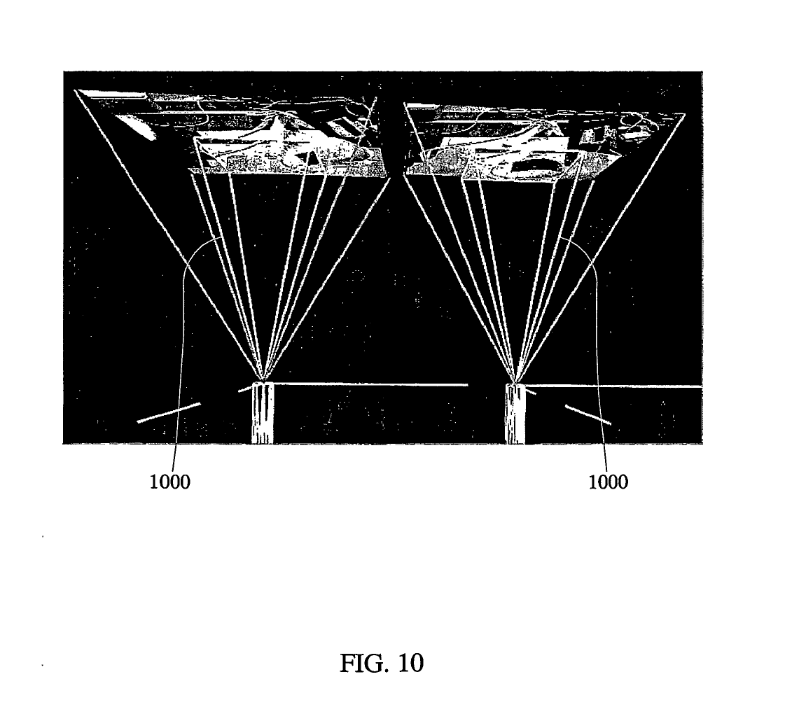

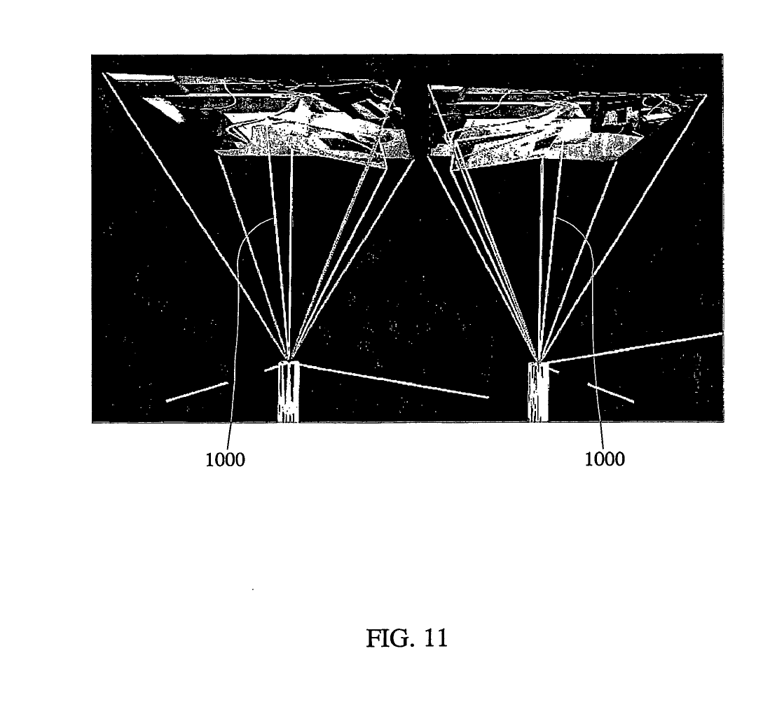

One issue considered early on during the implementation phase of this technique was the question of whether the verged display frustums should be sheared or rotated. FIGS. 10-12 respectively illustrate unconverged, rotated, and sheared display frustums that may be generated by dynamic virtual convergence module 218 according to an embodiment of the present invention. Referring to FIG. 10, display frustums 1000 are unconverged. This is the way that a conventional head mounted display with parallel cameras operates. In

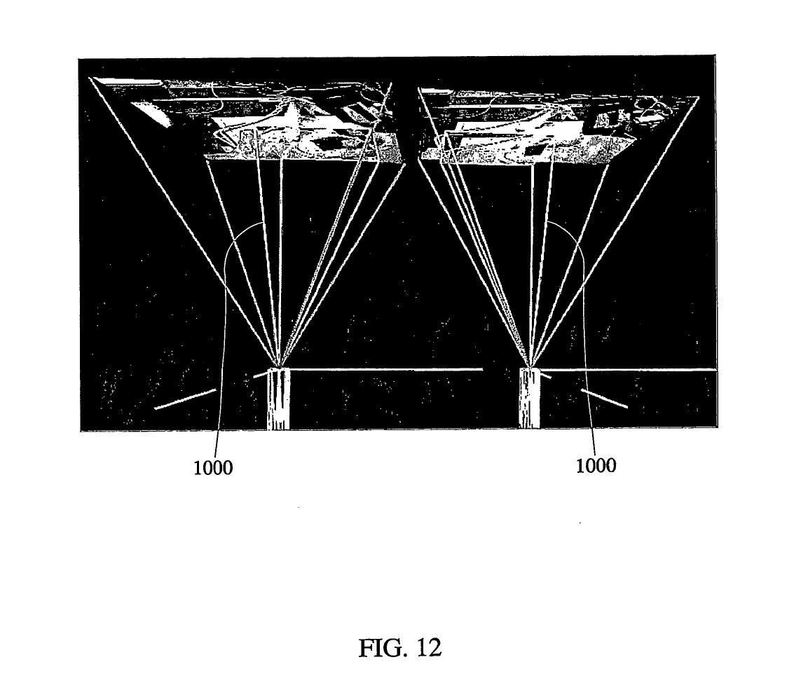

FIG. 11, display frustums 1000 are rotated to simulate viewing of close range objects to the user. In FIG. 12, display frustums 1000 are sheared in order to simulate viewing of close range objects to the user.

Shearing the frustums keeps the image planes for the left and right eyes coplanar, thus eliminating vertical disparity or dipvergence (Rolland1995] between the two images. At high convergence angles (i. e., for extreme close-up work), viewing such a stereo pair in the present system would be akin to wall-eyed fusion of images specifically prepared for cross-eyed fusion.

On the other hand, rotating the display frustums with respect to the camera frustums, while introducing dipvergence between corresponding features in stereo images, presents to each eye the very same retinal image it would see if the display were capable of physically toeing in (as discussed above), thereby also stimulating the user's eyes to toe in.

To compare these two methods for display frustum geometry, an interactive control (slider) was implemented in the user interface of dynamic virtual convergence module 218. For a given virtual convergence setting, blending between sheared and rotated frustums can be achieved by moving the slider. When that happens, the HMD user perceives a curious distortion of space, similar to a dynamic prismatic distortion. A controlled user study was not conducted to determine whether sheared or rotated frustums are preferable; rather, an informal group of testers was used and there was a definite preference towards the rotated frustums method overall. However, none of the testers found the sheared frustum images more difficult to fuse than the rotated frustum images, which is understandable given that sheared frustum stereo imagery has no dipvergence (as opposed to rotated frustum imagery). It is of course difficult to quantify the stereo perception experience without a carefully controlled study; for the present implementation on users' preferences were used as guidance for further development.

### Automating Virtual Convergence

One goal of the present invention was to achieve on-the-fly convergence changes under algorithmic control to allow users to work comfortably at different depths. Tests were performed to determine whether a human user could in fact tolerate dynamic virtual convergence changes at all. To this end, a user interface slider for controlling convergence was implemented. A human operator continually adjusted the slider while a user was viewing AR imagery in the VST-HMD. The convergence slider operator viewed the combined left-right (alternating at 60 Hz) SVGA signal fed to the Glasstron HMD on a separate monitor. This signal appears similar to a blend between the left and right eye images, and any disparity between the images is immediately apparent. The operator continuously adjusted the convergence slider, attempting to minimize the visual disparity between the images (thereby maximizing stereo overlap). This means that if most of the image consists of objects located close to the HMD user's head, the convergence slider operator tended to verge the display frustums inward. With practice, the operators became quite skilled; most test users had positive reactions, with only one user reporting extreme discomfort.

Another object of the invention was to create a real-time algorithmic implementation capable of producing a numeric value for display frustum convergence for each frame in the AR system. Three distinct approaches were considered for this:

(1) Image content based: This is the algorithmic version of the “manual” method described above. An attractive possibility would be to use a maximization of mutual information algorithm [Viola1995]. An image-based method could run as a separate process and could be expected to perform relatively quickly since it need only optimize a single parameter. This method should be applied to the mixed reality output rather than the real world imagery to ensure that the user can see virtual objects that are likely to be of interest. Under some conditions, such as repeating patterns in the images, a mutual information method would fail by finding an “optimal” depth value with no rational basis in the mixed reality. Under most conditions however, including color and intensity mismatches between the cameras, a mutual information algorithm would appropriately maximize the stereo overlap in the left and right eye images.

(2) Z-buffer based: This approach inspects values in the Z-buffer of each stereo image pair and (heuristically) determines a likely depth value to which the convergence should be set. [Ware1998] gives an example for such a technique.

(3) Geometry based: This approach is similar to (2) but uses geometry data (models as opposed to pixel depths) to (again heuristically) compute a likely depth value to which the convergence should be set. In other words, this method works on pre-rasterization geometry, whereas (2) uses post-rasterization geometry.

Approaches (1) and (2) both operate on finished images. Thus, they cannot be used to set the convergence for the current frame but only to predict a convergence value for the next frame. Conversely, approach (3) can be used to immediately compute a convergence value (and thus the final viewing transformations for the left and right display frustums) for the current frame, before any geometry is rasterized. However, as will be explained below, this does not automatically exclude (1) and (2) from consideration. Rather, approach (1) was eliminated on the grounds that it would require significant computational resources. A hybrid of methods (2) and (3) was developed, characterized by inspection of only a small subset of all Z-buffer values, and aided by geometric models and tracking information for the user's head as well as for handheld objects. The following steps describe a hybrid algorithm for determining a convergence distance according to an embodiment of the present invention:

1. For each eye, the full augmented view described above is rendered into the frame buffer (after capturing video, reading trackers, etc.).

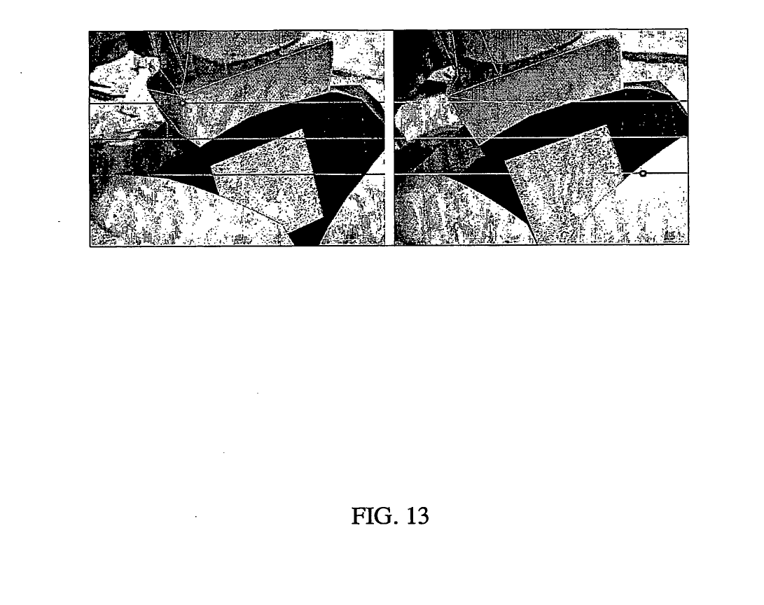

2. For each eye, inspect the Z-buffer of the finished view along 3 horizontal scan lines, located at heights h/3, h/2, and 2h/3 respectively, where h is the height of the image. FIG. 13 illustrates z buffer inspection along three selected scan lines. The highlighted points in each scan line represent the point in the scene that is closest to the user. Find the average of the closest depths zₘᵢₙ=(z_{min,l}+z_{min,r})/2. Set the convergence distance z to zₘᵢₙ for now. This step is only performed if in the previous frame the convergence distance was virtually unchanged (a threshold of 0.010 may be used). Otherwise z is left unchanged from the previous frame.

3. Using tracker information, determine if application-specific geometry (for example, the all-important ultrasound image in medical applications, such as ultrasound-guided breast cancer biopsies) is within the viewing frustum of either display. If so, set z to the distance of the ultrasound slice from the HMD.

4. Calculate the average value z_{avg} during the most recent n frames, not including the current frame since the above steps can only execute on a finished frame (steps 1-2) or at least on an already calculated display frustum (step 3).

5. Set the display frustums to point to a location at distance z_{avg} in front of the HMD. Calculate the appropriate transformations, taking into account the blending factor between sheared and rotated frustums (see Section 3.4). Go to step 1.

The simple temporal filtering in step 4 is used to avoid sudden, rapid changes. It also adds a delay in virtual convergence update, which for n=10 amounts to approximately 0.5 seconds at a frame rate of about 20 Hz (a better implementation would vary n as a function of frame rate in order to keep the delay constant). Even though this update seems slower than the human visual system's rather quick vergence response to the diplopia (double vision) stimulus, this update has not been found to be jarring or unpleasant.

The conditional update of z in Step 2 prevents most self-induced oscillations in convergence distance. Such oscillations can occur if the system continually switches between two (rarely more) different convergence settings, with the z-buffer calculated for one setting resulting in the other convergence setting being calculated for the next frame. Such a configuration may be encountered even when the user's head is perfectly still and none of the other tracked objects (such as handheld probe, pointers, needle, etc.) are moved.

### Results

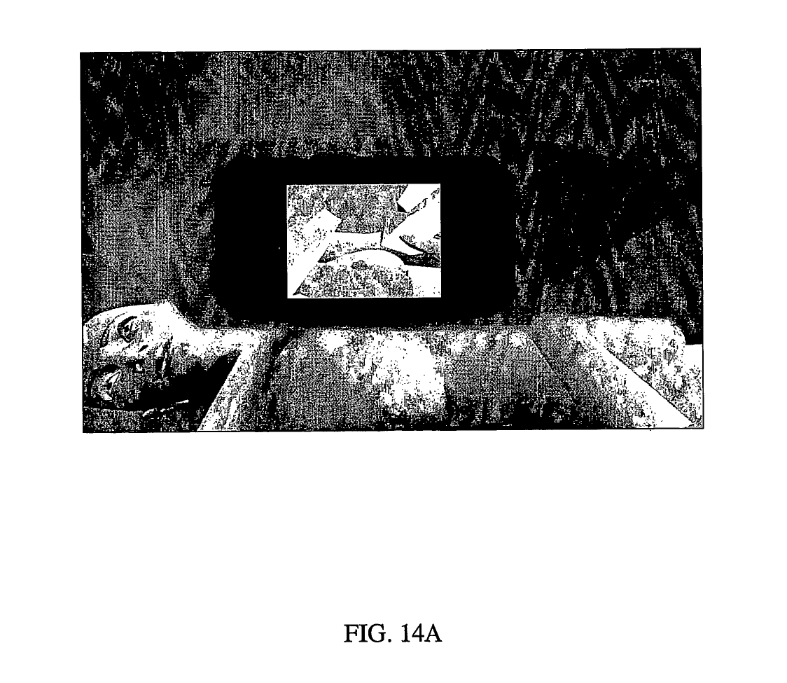

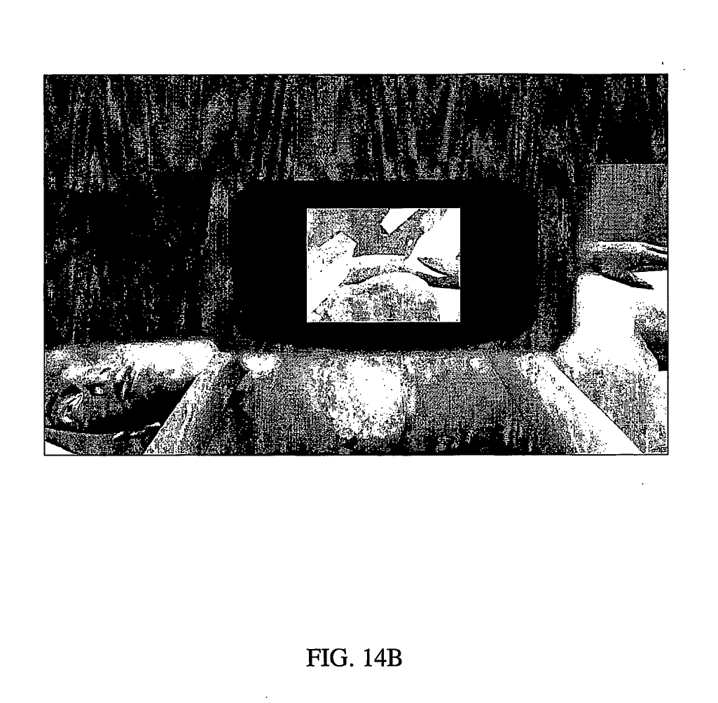

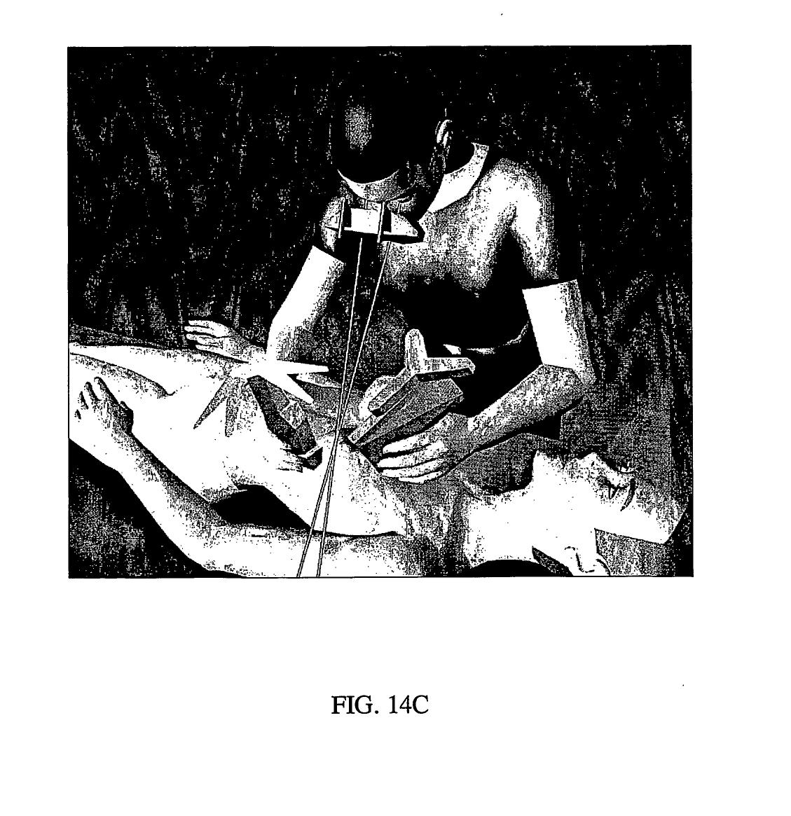

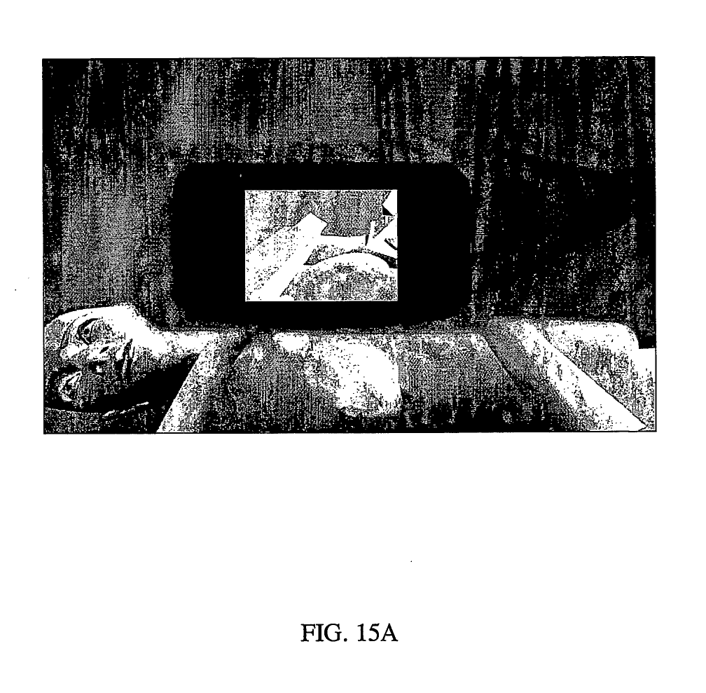

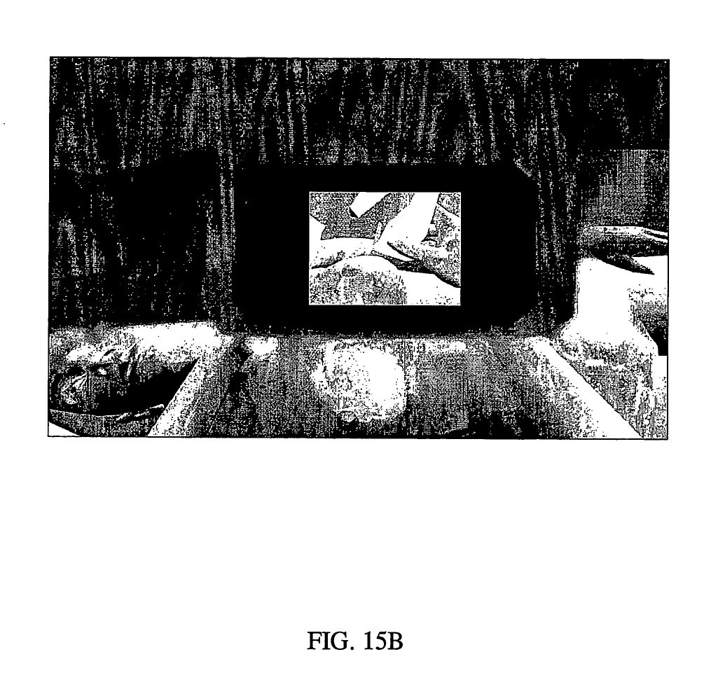

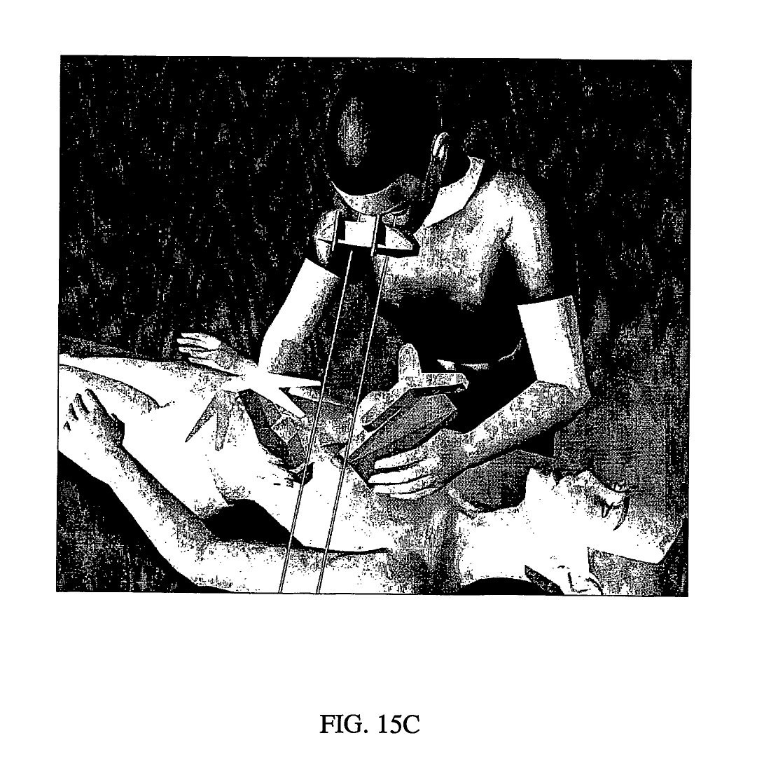

FIGS. 14A-15C illustrate simulated wide-angle stereo views from the point of view of an HMD wearer, illustrating the difference between converged and parallel operation. More particularly, FIGS. 14A and 14B are left and right views illustrating a converged view of a scene consisting of a breast cancer patient and an ultrasound probe. FIG. 14C is a model of the scene illustrating convergence of the left and right views in FIGS. 14A and 14B.

FIGS. 15A and 15B are simulated parallel views of a scene consisting of a breast cancer patient. FIG. 15C is a model of the scene illustrating the parallel views' seen by the user in FIGS. 15A and 15B.

The dynamic virtual convergence subsystem has been applied to two different AR applications. Both applications use the same modified Sony Glasstron HMD and the hardware and software described above. The first is an experimental AR system designed to aid physicians in performing minimally invasive procedures such as ultrasound-guided needle biopsies of the breast. This system and a number of recent experiments conducted with it are described in detail in [Rosenthal2001]. A physician used the system on numerous occasions, often for one hour or longer without interruption, while the dynamic virtual convergence algorithm was active. She did not report any discomfort while or after using the system. With her help, a series of experiments were conducted yielding quantitative evidence that AR-based guidance for the breast biopsy procedure is superior to the conventional guidance method in artificial phantoms [Rosenthal2001]. Other physicians and researchers have all used this system, albeit for shorter periods of time, without discomfort (except for one individual previously mentioned, who experiences discomfort whenever the virtual convergence is changed dynamically).

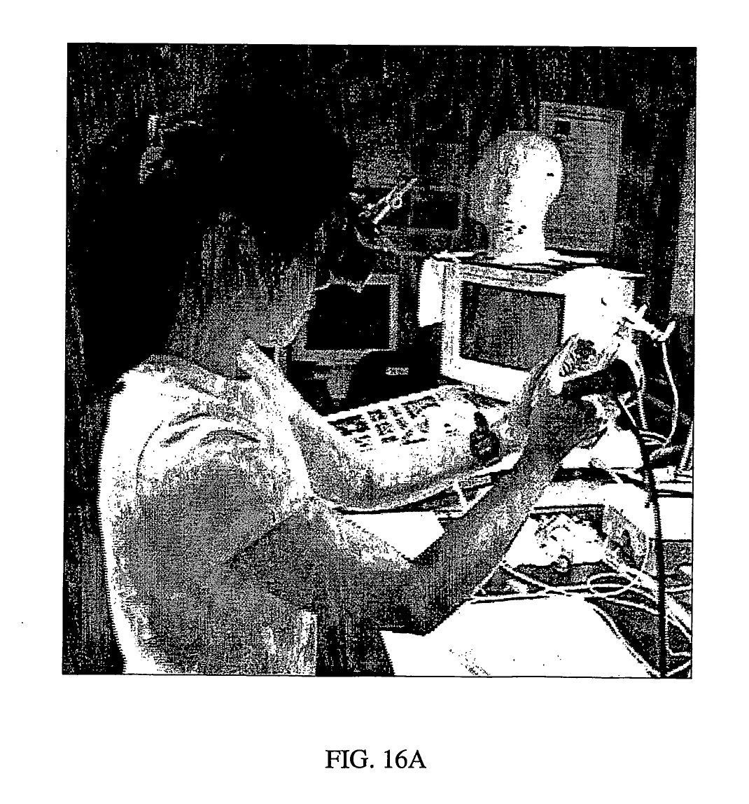

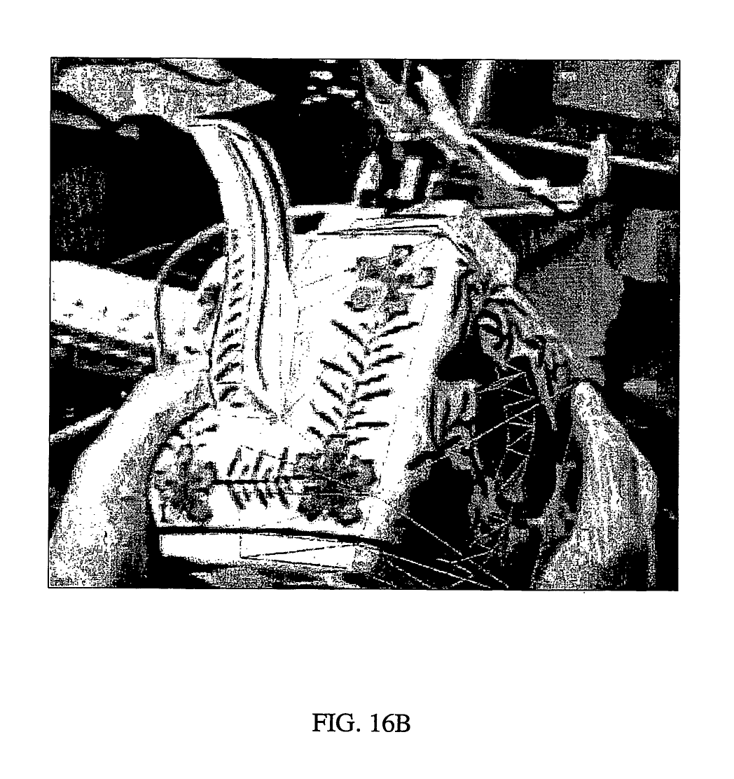

The second AR application to use dynamic virtual convergence is a system for modeling real objects using AR. FIGS. 16A and 16B illustrate the use of dynamic virtual convergence in an augmented reality system for modeling real objects. More particularly, in FIG. 16A, a viewer views a real object through a VST HMD with dynamic virtual convergence. FIG. 16B illustrates the corresponding object viewed at close range with an augmented reality image superimposed thereon. The system and the results obtained with the system are described in detail [Lee2001]. Two of the authors of [Lee2001) have used that system for sessions of one hour or longer, again without noticeable discomfort (immediate or delayed).

### Conclusions

Other authors have previously noted the conflict introduced in VST-HMDs when the camera axes are not properly aligned with the displays. While this is significant, significance violating this constraint may be advantageous in systems requiring the operator to use stereoscopic vision at several distances. Mathematical models such as those developed by [Takagi2000] demonstrate the distortion of the visual world. These models do not demonstrate the volume of the visual world that is actually stereo-visible (i.e., visible to both eyes and within 1-2 degrees of center of stereo-fused content). Dynamically converging the cameras—whether they are real cameras as in [Matsunaga2000] or virtual cameras (i.e., display frustums) pointed at video-textured polygons as in embodiments of the present invention—makes a greater portion of the near field around the point of convergence stereoscopically visible at all times. Most users have successfully used the AR system with dynamic virtual convergence described herein to place biopsy and aspiration needles with high precision or to model objects with complex shapes. The distortion of the perceived visual world is not as severe as predicted by the mathematical models if the user's eyes converge at the distance selected by the system. (If they converge at a different distance, stereo overlap is reduced and increased spatial distortion and/or eye strain may be the result. The largely positive experience with this technique is due to a well-functioning convergence depth estimation algorithm.) Indeed, a substantial degree of perceived distortion is eliminated if one assumes that the operator has approximate knowledge of the distance to the point being converged on (experimental results in (Milgram1992] support this statement). Given the intensive hand-eye coordination required for medical applications, it seems reasonable to conjecture that users' perception of their visual world may be rectified by other sources of information such as seeing their own hand. Indeed, the hand may act as a “visual aid” as defined by [Milgram1992]. This type of adaptation is apparently well within the abilities of the human visual system as evidenced by the ease with which individuals adapt to new eyeglasses and to using binocular magnifying systems.

### Future Work

Dynamic virtual convergence reduces the accommodation-vergence conflict while introducing a disparity-vergence conflict. It may be useful to investigate whether smoothly blending between zero and full virtual convergence is useful. Also, should that a parameter to be set on a per user basis, per session basis, or dynamically? Second, a thorough investigation of sheared vs. rotated frustums (should that be changed dynamically as well?), as well as a controlled user study for the entire system, with the goal of obtaining quantitative results, seem desirable.

### References

The references listed below as well as all references cited in the specification are incorporated herein by reference to the extent that they supplement, explain, provide a background for or teach methodology, techniques and/or embodiments described herein.

Akka, Robert. “Automatic software control of display parameters for stereoscopic graphics images.” SPIE Volume 1669, Stereoscopic Displays and Applications III (1992), 31-37.

Azuma, Ronald T. “A Survey of Augmented Reality.” Presence: Teleoperators and Virtual Environments 6, 4 (August 1997), MIT Press, 355-385.

Bajura, Michael, Henry Fuchs, and Ryutarou Ohbuchi. “Merging Virtual Objects with the Real World: Seeing Ultrasound Imagery within the Patient.” Proceedings of SIGGRAPH '92 (Chicago, Ill., Jul. 26-31, 1992). In Computer Graphics 26, #2 (July 1992), 203-210.

Drascic, David, and Paul Milgram. “Perceptual Issues in Augmented Reality.” SPIE Volume 2653; Stereoscopic Displays and Virtual Reality Systems III (1996),123-124.

Fuchs, Henry, Mark A. Livingston, Ramesh Raskar, D'nardo Colucci, Kurtis Keller, Andrei State, Jessica R. Crawford, Paul Rademacher, Samuel H. Drake, and Anthony A. Meyer, MD. “Augmented Reality Visualization for Laparoscopic Surgery.” Proceedings of Medical Image Computing and Computer-Assisted Intervention.MICCAI '98 (Cambridge, Mass., USA, Oct. 11-13, 1998), 934-943.

Kanbara, M., T. Okuma, H. Takemura, N. Yokoya, “A Stereoscopic Video See-through Augmented Reality System Based on Real-time Vision-Based Registration.” Proceedings of Virtual Reality 2000, March 2000, 255-262.

Lee, Joohi, Gentaro Hirota, and Andrei State. “Modeling Real Objects Using Video See-Through Augmented Reality.” Proceedings of the Second International Symposium on Mixed Reality (ISMR 2001), Mar. 14-15, 2001, Yokohama, Japan, 19-26.

Matsunaga, Katsuya, Tomohide Yamamoto, Kazunori Shidoji, and Yuji Matsuki. “The effect of the ratio difference of overlapped areas of stereoscopic images on each eye in a teleoperation.” SPIE Vol. 3957, Stereoscopic Displays and Virtual Reality Systems VII (2000),236-243.

Milgram, P., and Martin Kruger. “Adaptation Effects in Stereo Due To Online Changes in Camera Configuration.” SPIE Vol. 1669-13, Stereoscopic Displays and Applications III (1992),122-134.

Robinett, Warren, and Jannick P. Rolland. “A Computational Model for the Stereoscopic Optics of a Head-Mounted Display.” Presence: Teleoperators and Virtual Environments 1, 1 (Winter 1992), MIT Press, 45-62.

Rolland, Jannick, and William Gibson. “Towards Quantifying Depth and Size Perception in Virtual Environments.” Presence: Teleoperators and Virtual Environments 4, 1 (Winter 1995), MIT Press, 24-49.

Rosenthal, Michael, Andrei State, Joohi Lee, Gentaro Hirota, Jeremy Ackerman, Kurtis Keller, Etta D. Pisano, Michael Jiroutek, Keith Muller, and Henry Fuchs. “Augmented Reality Guidance for Needle Biopsies: A Randomized, Controlled Trial in Phantoms.” To appear in the Proceedings of Medical Image Computing and Computer-Assisted Intervention.MICCAI 2001 (Utrecht, The Netherlands, 14-17 Oct. 2001).

State, Andrei, Mark A. Livingston, Gentaro Hirota, William F. Garrett, Mary C. Whitton, Henry Fuchs, and Etta D. Pisano (MD). “Technologies for Augmented-Reality Systems: Realizing Ultrasound-Guided Needle Biopsies.” Proceedings of SIGGRAPH '96 (New Orleans, La., Aug. 4-9, 1996). In Computer Graphics Proceedings, Annual Conference Series 1996, ACM SIGGRAPH, 439-446.

Takagi, A., S. Yamazaki, Y. Saito, and N. Taniguchi. “Development of a stereo video see-through HMD for AR systems.” Proceedings of International Symposium on Augmented Reality (ISAR) 2000, 68-77.

Viola, P. and W. Wells. “Alignment by Maxmization of Mutual Information.” International Conference on Computer Vision, Boston, Mass., 1995.

Ware, Colin, Cyril Gobrect, and Mark Paton. “Dynamic adjustment of stereo display parameters.” IEEE Transactions on Systems, Man and Cybernetics, 28(1), 56-65.

Watson, Benjamin A., Larry F. Hodges. “Using Texture maps to Correct for Optical Distortion in Head-Mounted Displays.” Proceedings of the Virtual Reality Annual Symposium '95, IEEE Computer Society Press, 1995, 172-178.

It will be understood that various details of the invention may be changed without departing from the scope of the invention. Furthermore, the foregoing description is for the purpose of illustration only, and not for the purpose of limitation, as the invention is defined by the claims as set forth hereinafter.

What is claimed is:

1. A method for dynamic virtual convergence for video see through head mountable displays to allow stereoscopic viewing of close-range objects, the method comprising:
(a) sampling an image with the first and second cameras, each camera having a first field of view;
(b) estimating a gaze distance for a viewer;
(c) transforming display frustums to converge at the estimated gaze distance;
(d) reprojecting the image sampled by the cameras into the display frustums; and
(e) displaying the reprojected image to the viewer on displays having a second field of view smaller than the first field of view, thereby allowing stereoscopic viewing of close range objects.

2. The method of claim 1 wherein sampling an image with the first and second cameras includes obtaining video samples of an image.

3. The method of claim 1 wherein estimating a gaze distance includes tracking objects within the camera fields of view and applying a heuristic to estimate the gaze distance based on the distance from the cameras to at least one of the tracked objects.

4. The method of claim 1 wherein transforming the display frustums to converge at the estimated gaze distance includes rotating the display frustums to converge at the estimated gaze distance.

5. The method of claim 1 wherein transforming the display frustums to converge at the estimated gaze distance includes shearing the display frustums to converge at the estimated gaze distance.

6. The method of claim 1 wherein transforming the display frustums to converge at the estimated gaze distance includes transforming the display frustums without moving the cameras.

7. The method of claim 1 wherein displaying the reprojected image to a user includes reprojecting the images to the user on first and second display screens in a video-see-through head mountable display.

8. The method of claim 1 comprising adding an augmented reality image to the displayed image.

9. A method for estimating convergence distance of a viewer's eyes when viewing a scene through a video-see-through head mountable display, the method comprising:
(a) creating depth buffers for each pixel in a scene viewable by each of a viewer's eyes through a video-see-through head mountable display using known information about the scene, positions of tracked objects in the scene, and positions of each of the viewer's eyes; and
(b) examining predetermined scan lines in each depth buffer and determining a closest depth value for each of the viewer's eyes;
(c) averaging the depth values for the viewer's eyes to determine an estimated convergence distance;
(d) determining whether depths of any tracked objects override the estimated convergence distance; and
(e) determining a final convergence distance based on the estimated convergence distance and the determination in step (d).

10. The method of claim 9 comprising filtering the final convergence distance to dampen high frequency changes in the final convergence distance and avoid oscillations of the final convergence distance.

11. The method of claim 1 1 wherein filtering the final convergence distance includes temporally averaging a predetermined number of recently calculated convergence distance values.

12. A head mountable display system for displaying real and augmented reality images in stereo to a viewer, the system comprising:
(a) a main body including a tracker for tracking position of a viewer's head, first and second cameras for obtaining images of an object of interest, and first and second mirrors for reprojecting virtual centroids of the cameras to centroids of the viewer's eyes; and
(b) a display unit including first and second displays for receiving the images sampled by the cameras and displaying the images to the viewer.

13. The system of claim 12 wherein the main body includes a tracker mounting portion and first, second, and third light emitting elements for tracking the position of the user's head.

14. The system of claim 13 wherein the tracker mounting portion is substantially triangular shaped and the first, second, and third light emitting elements are located at vertices of a triangle formed by the tracker mounting portion.

15. The system of claim 12 wherein the main body includes first and second opposing portions for holding the first and second mirrors.

16. The system of claim 12 wherein the first mirror is located opposite the cameras and the second mirror is located opposite the first mirror.

17. The system of claim 16 wherein the first mirror is adapted to project the camera centroids into the first mirror and the first and second mirrors are spaced from each other and oriented such that camera centroids correspond to the positions of the viewer's eyes.

18. The system of claim 12 wherein the second mirror is angled to reflect images of an object being viewed and the second mirror is of unitary construction.

19. The system of claim 12 wherein the second mirror comprises left and right portions located close to each other.

20. The system of claim 12 wherein the fields of view of the displays are smaller than fields of view of the cameras.

21. The system of claim 12 wherein the cameras are stationary.
